(19) United States
(12) Patent Application Publication
(10) Pub. No.: US 2013/0282709 A1
(43) Pub. Date: Oct. 24, 2013

(54) METHOD AND SYSTEM FOR QUERY SUGGESTION

(71) Applicants: Shenhong Zhu, Santa Clara, CA (US); Ethan Batraski, Foster City, CA (US); Hang Su, Sunnyvale, CA (US); Hui Wu, Fremont, CA (US)

(72) Inventors: Shenhong Zhu, Santa Clara, CA (US); Ethan Batraski, Foster City, CA (US); Hang Su, Sunnyvale, CA (US); Hui Wu, Fremont, CA (US)

(73) Assignee: YAHOO! INC., Sunnyvale, CA (US)

(21) Appl. No.: 13/449,748

(22) Filed: Apr. 18, 2012

(51) Int. Cl. G06F 17/30

(52) U.S. Cl. 707/728; 707/767; 707/E17.066

(57) ABSTRACT

Method, system, and programs for context-based query suggestion are disclosed. A user input is received first. The user input is associated with a request for query suggestion and a page identifier for identifying a page on which a user is browsing. A plurality of page aboutnesses of the page are then fetched from a database based on the received page identifier. A plurality of query suggestions are determined based on the fetched plurality of page aboutnesses. The determined plurality of query suggestions are provided to the user.

### BACKGROUND

1. Technical Field

The present teaching relates to methods, systems, and programming for Internet services. Particularly, the present teaching is directed to methods, systems, and programming for query suggestion.

2. Discussion of Technical Background

Online content search is a process of interactively searching for and retrieving requested information via a search application running on a local user device, such as a computer or a mobile device, from online databases. Online search is conducted through search engines, which are programs running at a remote server and searching documents for specified keywords and return a list of the documents where the keywords are found. Known major search engines have a feature called “query suggestion” designed to help users narrow in on what they are looking for. For example, as users type a search query, known solutions display a list of query suggestions that have been used by many other users before to assist the users in selecting a desired search query before they hit the actual search button or any specific hyperlink.

FIG. 1 illustrates a prior art system 100 for query suggestion. The prior art system 100 includes a prefix matching-based query suggestion engine 102, a query suggestion database 104, and one or more search behavior databases 106 including a query log database 108 and a knowledge database 110. A user 112 in this example interacts with the prefix matching-based query suggestion engine 102 to provide a search query, e.g., a string or one or more characters, and receive query suggestions. The suggestions are determined by prefix matching of the received query string with all the query strings stored in the query suggestion database 104 and are ranked by certain ranking features of each matching query strings, which may include query frequency, query length, etc. In the prior art system 100, the query suggestion database 104 is built offline by mining search logs stored in the query log database 108 and combining additional information from the knowledge database 110. The query suggestions are provided based on user's input or previous issued queries, either in the same session or a while ago. In other words, the known query suggestion solutions, such as the prior art system 100, focus only on users' search behavior but ignore the users' browsing behavior. For example, as shown in FIG. 2, when a user types “bas” in the search box of YAHOO! homepage, query suggestions such as “bass pro shop,” “basketball,” “baskin robbins,” “bassett furniture,” etc., which are the most popular queries with the prefix “bas” that have been mined offline from query logs. The suggested queries, however, may be completely irrelevant as the intent or interest of the specific user has not been taken into consideration when the query suggestions were picked up.

Therefore, there is a need to provide an improved solution for query suggestion to solve the above-mentioned problems.

### SUMMARY

The present teaching relates to methods, systems, and programming for Internet services. Particularly, the present teaching is directed to methods, systems, and programming for query suggestion.

In one example, a method, implemented on at least one machine each of which has at least one processor, storage, and a communication platform connected to a network for context-based query suggestion, is disclosed. A user input is received first. The user input is associated with a request for query suggestion and a page identifier for identifying a page on which a user is browsing. A plurality of page aboutnesses of the page are then fetched from a database based on the received page identifier. A plurality of query suggestions are determined based on the fetched plurality of page aboutnesses. The determined plurality of query suggestions are provided to the user.

In another example, a method, implemented on at least one machine each of which has at least one processor, storage, and a communication platform connected to a network for context-based query suggestion, is disclosed. A request is received first. The request is associated with a page identifier for analyzing a plurality of page aboutnesses of a page on which a user is browsing. The page is identified by the page identifier. Content of the page is then fetched based on the page identifier. The plurality of page aboutnesses are extracted by analyzing the fetched content of the page. The plurality of page aboutnesses are ranked based on a relevance score associated with each page aboutness. The ranked plurality of page aboutnesses are indexed with the page identifier. The indexed plurality of page aboutnesses and the page identifier are stored in a database. At least some of the stored plurality of page aboutnesses are used as query suggestions in response to a user input associated with a request for query suggestion and the page identifier.

In still another example, a method, implemented on at least one machine each of which has at least one processor, storage, and a communication platform connected to a network for context-based query suggestion, is disclosed. A request is sent first. The request is associated with a page identifier for analyzing a plurality of page aboutnesses of a page on which a user is browsing. The page is identified by the page identifier. A user input associated with a request for query suggestion and the page identifier is sent. A plurality of query suggestions are received as a response to the user input. Content of the page is fetched based on the page identifier. A plurality of page aboutnesses are extracted based on the content of the page. The plurality of query suggestions are determined based on the plurality of page aboutnesses.

In a different example, a system for context-based query suggestion is disclosed. The system comprises a context-based query suggestion engine and a page aboutness analyzing engine. The context-based query suggestion engine includes a page aboutness retrieving unit and a context-based query suggestion generator. The page aboutness retrieving unit is configured to receive a user input associated with a request for query suggestion and a page identifier for identifying a page on which a user is browsing. The page aboutness retrieving unit is also configured to fetch a plurality of page aboutnesses of the page from a database based on the received page identifier. The context-based query suggestion generator is configured to determine a plurality of query suggestions based on the fetched plurality of page aboutnesses. The context-based query suggestion generator is also configured to provide the determined plurality of query suggestions to the user.

Other concepts relate to software for context-based query suggestion. A software product, in accord with this concept, includes at least one machine-readable non-transitory medium and information carried by the medium. The information carried by the medium may be executable program code data regarding parameters in association with a request or operational parameters, such as information related to a user, a request, or a social group, etc.

In one example, a machine readable and non-transitory medium having information recorded thereon for context-based query suggestion, wherein the information, when read by the machine, causes the machine to perform a series of steps. A user input is received first. The user input is associated with a request for query suggestion and a page identifier for identifying a page on which a user is browsing. A plurality of page aboutnesses of the page are then fetched from a database based on the received page identifier. A plurality of query suggestions are determined based on the fetched plurality of page aboutnesses. The determined plurality of query suggestions are provided to the user.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts a prior art system for query suggestion;

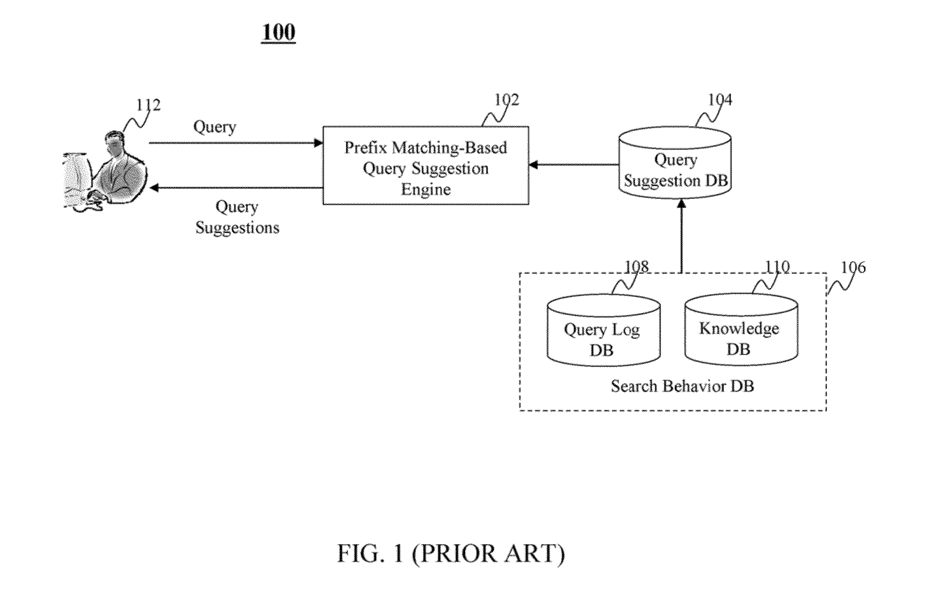

FIG. 2 illustrates one example of query suggestion by the prior art system shown in FIG. 1;

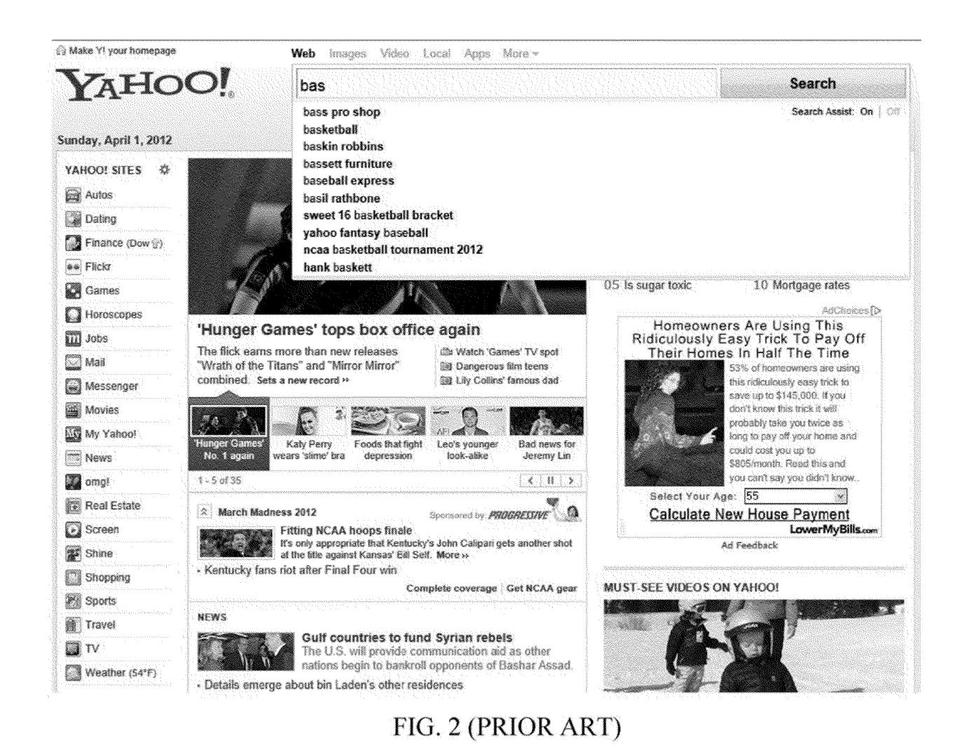

FIG. 3 is a high level exemplary system diagram of a system for context-based query suggestion, according to an embodiment of the present teaching;

FIG. 4 is a flowchart of an exemplary process for context-based query suggestion, according to an embodiment of the present teaching;

FIG. 5 is an exemplary diagram of a user application of the system for context-based query suggestion shown in FIG. 3, according to an embodiment of the present teaching;

FIG. 6 is a flowchart of another exemplary process for context-based query suggestion, according to an embodiment of the present teaching;

FIG. 7 is an exemplary diagram of a page aboutness analyzing engine and page aboutness database of the system for context-based query suggestion shown in FIG. 3, according to an embodiment of the present teaching;

FIG. 8 is a flowchart of still another exemplary process for context-based query suggestion, according to an embodiment of the present teaching;

FIG. 9 is an exemplary diagram of a context-based query suggestion engine of the system for context-based query suggestion shown in FIG. 3, according to an embodiment of the present teaching;

FIG. 10 is a flowchart of yet another exemplary process for context-based query suggestion, according to an embodiment of the present teaching;

FIG. 11 depicts an exemplary embodiment of a networked environment in which context-based query suggestion is applied, according to an embodiment of the present teaching; and

FIG. 12 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of efficient and effective query suggestion. The method and system as disclosed herein aim at improving end-users' search experience by instantly providing more relevant query suggestions based on not only users' search behavior but also the users' search context. The context includes the users' browsing behavior, which is important for predicting the users' search intent. The present disclosure describes a context-sensitive query suggestion solution of making full use of the user's browsing behavior. Because of this consideration, the method and system can recommend more relevant queries so that the users can re-organize their queries more efficiently, which further improves search experience.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

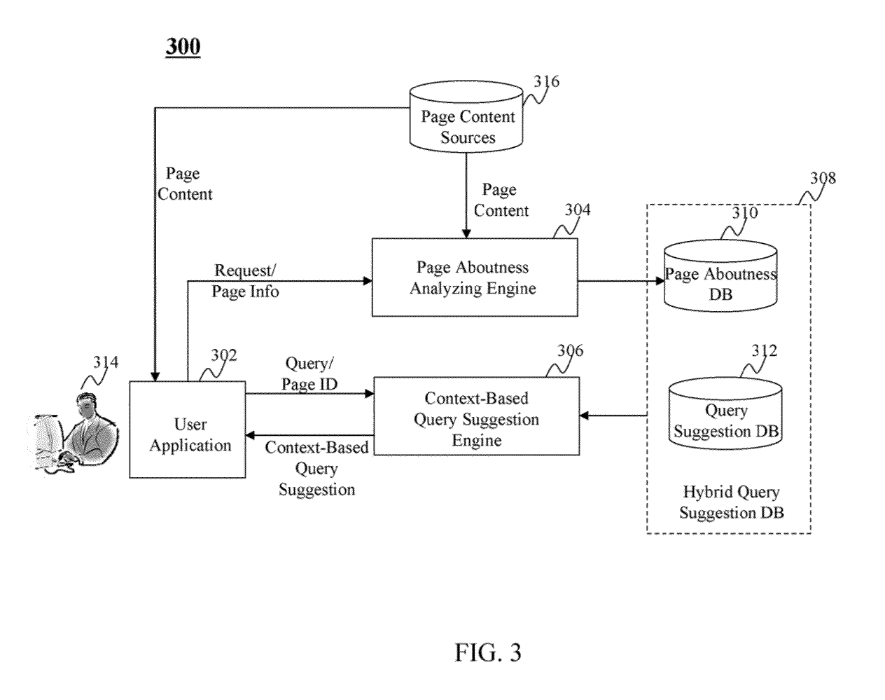

FIG. 3 is a high level exemplary system diagram of a system for context-based query suggestion, according to an embodiment of the present teaching. The system 300 in this example includes a user application 302, a page aboutness analyzing engine 304, a context-based query suggestion engine 306, and a hybrid query suggestion database 308 having a page aboutness database 310 and a query suggestion database 312. A user 314 in this example performs an online search through the user application 302 and instantly receives query suggestions from the remote context-based query suggestion engine 306 based on the context of the online search, e.g., the page aboutnesses of the webpage the user 314 has been browsing. The page aboutnesses are analyzed by the page aboutness analyzing engine 304, and the results are stored in the page aboutness database 310.

The user application 302 may reside on a user device (not shown), such as a laptop computer, desktop computer, netbook computer, media center, mobile device (e.g., a smart phone, tablet, music player, and GPS), gaming console, set-top box, printer, or any other suitable device. The user application 302 may be a web browser or a standalone search application, which is pre-installed on the user device by the vendor of the user device or installed by the user 314. The user application 302 may serve as an interface between the user 314 and the remote page aboutness analyzing engine 304 and context-based query suggestion engine 306. The user application 302 may be stored in a storage on the user device and loaded into a memory once it is launched by the user 314. Once the user application 302 is executed by one or more processors on the user device, the page information of the currently loaded webpage is automatically sent to the page aboutness analyzing engine 304 by the user application 302. Once the user 314 starts to enter a query, the query along with a page identifier, e.g., a uniform resource locator (URL), IP address, alias, etc., of the webpage, are submitted by the user application 302 to the context-based query suggestion engine 306. The context-based query suggestion engine 306 then returns context=based query suggestions to the user 314 through the user application 302 based on the received query and page identifier.

The page aboutness analyzing engine 304 in this example is responsible for analyzing the content on the webpage on which the user 314 is browsing and extracting page aboutness, e.g., entities, topics, and keywords, about the page, based on the received page information. In this example, the page information may include the page identifier, e.g., a URL, IP address, alias, etc., and a page content signature hint. The page content to be analyzed is fetched by the page aboutness analyzing engine 304 from remote page content sources, e.g., servers of websites. In other examples, the page content may be part of the page information and is transmitted from the user application 302 directly to the page aboutness analyzing engine 304 since it has already been downloaded by the user application 302. Multiple page aboutnesses for the same page are ranked and stored into the page aboutness database 310. As the same content on a particular webpage may have been analyzed recently, its page aboutnesses may have been stored in the page aboutness database 310. Thus, the page aboutness analyzing engine 304 may first evaluate the page information associated with each request to determine whether page aboutness of a particular page needs to be extracted if the page has not been analyzed before or the stored page aboutnesses need to be updated.

The query suggestion database 312 is this example may be similar to the query suggestion database 104 in the prior art system 100. The query suggestion database 312 may be built offline based on data mining on historical users query logs and other knowledge data, which reflects users' collective search behavior pattern and trend. The page aboutness database 310 contains ranked page aboutnesses for each particular webpage, which represent the interest and search intent of users who are currently browsing on the particular webpage. Both the page aboutnesses and offline built query suggestions in the hybrid query suggestions database 308 may be utilized by the context-based query suggestion engine 306 when making query suggestions.

The context-based query suggestion engine 306 in this example is responsible for receiving the query and page identifier of the page on which the user 314 is browsing and retrieving corresponding page aboutnesses from the page aboutness database 310. The context-based query suggestion engine 306 is further configured to generate a context-sensitive query suggestions list based on the ranked page aboutnesses. As mentioned above, optionally, the offline built query suggestions from the query suggestion database 312 may be utilized by the context-based query suggestion engine 306 to determine part of the query suggestions in the list.

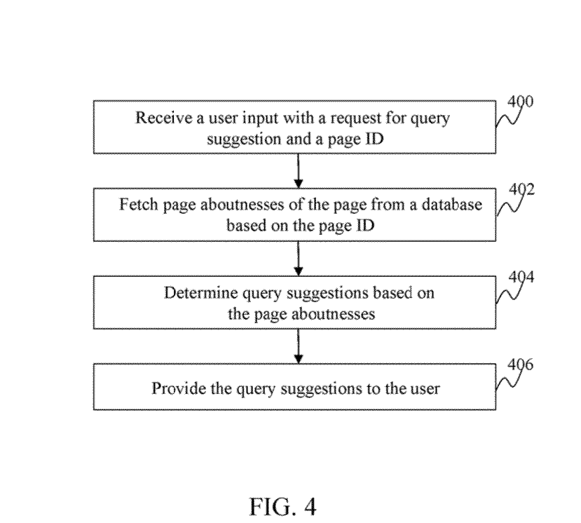

FIG. 4 is a flowchart of an exemplary process in which context-based query suggestion is performed, according to an embodiment of the present teaching. It will be described with reference to the above figures. However, any suitable module or unit may be employed. Beginning at block 400, a user input associated with a request for query suggestion and a page identifier is received from a user. The page identifier, such as a URL, identifies a page on which the user is browsing. At block 402, processing may continue where a plurality of page aboutnesses of the page are fetched from a database, for example, the page aboutness database 310, based on the received page identifier. Moving to block 404, a plurality of query suggestions are determined based on the fetched plurality of page aboutnesses. At block 406, the determined plurality of query suggestions are provided to the user. As described above, blocks 400, 402, 404, 406 may be performed by the context-based query suggestion engine 306.

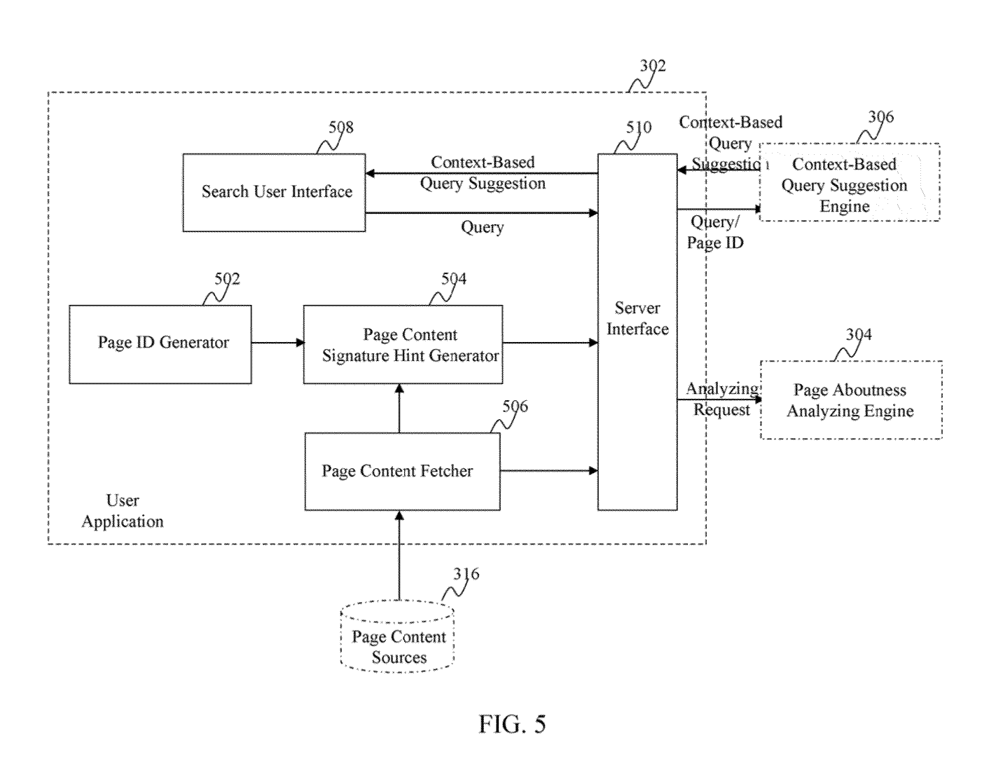

FIG. 5 is an exemplary diagram of a user application of the system for context-based query suggestion shown in FIG. 3, according to an embodiment of the present teaching. The user application 302 may include a page identifier generator 502, a page content signature hint generator 504, a page content fetcher 506, a search user interface 508, and a server interface 510. The page identifier generator 502 is configured to capture the page identifier that uniquely identifies the webpage on which the user is browsing. The page identifier may be, for example, the URL, IP address, alias, or any other suitable identifier that is recognized by the remote content-based query suggestion engine 306 and page aboutness analyzing engine 304. Based on the page identifier, e.g., the URL in the address bar of a web browser, the page content fetcher 506 is responsible for fetching corresponding content from remote page content sources, e.g., servers of websites. The page content signature hint generator 504 in this example is configured to create a page content signature hint based on the content of the page. The page content signature hint may be created by, for example, w-shingle based or any other known page similarity signature algorithm.

The search user interface 508 in this example includes, for example, a search bar and a query suggestion panel for receiving a user input associated with a search suggestion request from the user and displaying context-based query suggestions to the user, respectively. It is understood that in some examples, certain user inputs without any query, i.e., the user input text being empty, may be considered a request for query suggestion (suggestions before the user type). For example, moving a cursor onto the search bar or pressing a predefined key in the search bar may also trigger the display of context-based query suggestions. The user application 302 interacts with the remote context-based query suggestion engine 306 and page aboutness analyzing engine 304 through the server interface 510. In this example, the user application 302 interacts with the page aboutness analyzing engine 304 in an asynchronous manner. In one example, it waits until the page is fully loaded before sending an analyzing request to the page aboutness analyzing engine 304 in order for the page content signature hint generator 504 to generate the page content signature hint. The request associated with the page identifier and page content signature hint is then automatically sent through the server interface 510 to the page aboutness analyzing engine 304 once the page is fully loaded regardless of whether the search user interface 508 has received any input from the user. In another example, the user application 302 automatically sends the request associated with the page identifier through the server interface 510 as soon as the user application 302 starts to load the page. In other examples, instead of the page identifier, the content of the page fetched by the page content fetcher 506 may be associated with the analyzing request and sent to the page aboutness analyzing engine 304 for extracting page aboutness.

Once the search user interface 508 receives a user input associated with a query, e.g., typing a query string or character in the search box, the user application 302 sends a request for query suggestion and the page identifier to the context-based query suggestion engine 306 through the server interface 510. A list of context-based query suggestions is received through the server interface 510 from the context-based query suggestion engine 306 as a response to the user input and is presented to the user through the search user interface 508.

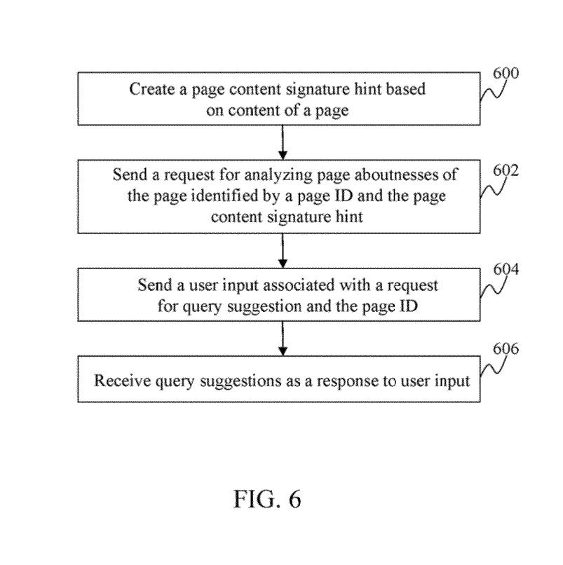

FIG. 6 is a flowchart of an exemplary process in which context-based query suggestion is performed, according to an embodiment of the present teaching. It will be described with reference to the above figures. However, any suitable module or unit may be employed. Beginning at block 600, a page content signature hint is created based on the content of a page. The content of the page is fetched based on a page identifier. At block 602, a request associated with the page identifier and the page content signature hint is sent for analyzing a plurality of page aboutnesses of the page on which a user is browsing. A plurality of page aboutnesses are extracted based on the content of the page. At block 604, a user input associated with a request for query suggestion and the page identifier is sent. At block 606, processing may continue where a plurality of query suggestions are received as a response to the user input. The plurality of query suggestions are determined based on the plurality of page aboutnesses. As described above, blocks 600, 602, 604, 606 may be performed by the user application 302.

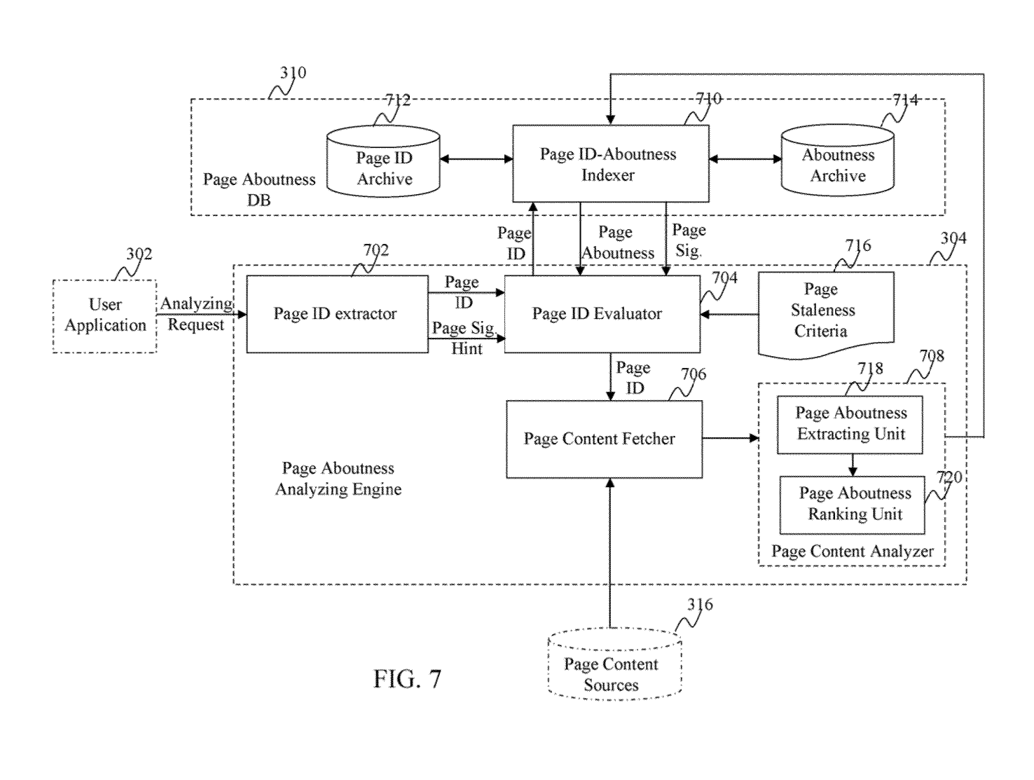

FIG. 7 is an exemplary diagram of a page aboutness analyzing engine and page aboutness database of the system for context-based query suggestion shown in FIG. 3, according to an embodiment of the present teaching. The page aboutness analyzing engine 304 in this example includes a page identifier extractor 702, a page identifier evaluator 704, a page content fetcher 706, and a page content analyzer 708. The page aboutness database 310 in this example includes a page identifier-aboutness indexer 710, a page identifier archive 712, and an aboutness archive 714.

The page identifier extractor 702 in this example is configured to receive a request associated with a page identifier from the user application 302 for analyzing page aboutness of the page on which the user is browsing and extract the page identifier from the request. If the request is also associated with a page content signature hint, the page identifier extractor 702 is further configured to extract the page content signature hint. The page identifier and page content signature hint if any are fed into the page identifier evaluator 704. The page identifier evaluator 704 is configured to determine whether the requested page aboutnesses can be fetched from the page aboutness database 310 based on the extracted page identifier. The page identifier evaluator 704 may adopt certain rules to determine whether it needs to fetch the page content and process it to extract the page aboutness. The page identifier evaluator 704 may first determine whether the page identifier has already been stored in the page aboutness database 310 by searching all the page identifiers stored in the page identifier archive 712. In one example, if a matching has been found, the page identifier evaluator 704 then may retrieve stored page aboutnesses associated with the stored page identifier from the aboutness archive 714 based on an index in the page identifier-aboutness indexer 710. The page identifier evaluator 704 then further examines whether the stored page aboutnesses need to be updated based on page staleness criteria 716. The page staleness criteria 716 may include, for example, a fixed time threshold or certain page attributes, such as content change frequency history, etc. In another example, if a page content signature hint is extracted from the analyzing request, the page identifier evaluator 704 may retrieve the stored page content signature associated with the stored page identifier from the page aboutness database 310. The page identifier evaluator 704 then may determine whether stored page aboutnesses associated with the stored page identifier need to be updated based on a difference between the extracted page content signature hint and the retrieved page content signature. For example, if more than v shingles out of the w shingles are different between the extracted page content signature hint and the retrieved page content signature, it means the content of the page has been significantly changed since last update and thus, needs to be re-analyzed.

If the page identifier evaluator 704 determines that the page aboutnesses of the requested page need to be extracted because the page has not been analyzed before or need to be re-extracted, the page identifier is sent to the page content fetcher 706. The page content fetcher 706 is configured to, if the requested page aboutnesses cannot be fetched from the page aboutness database 310, fetch content of the page from the page content sources 316 based on the page identifier. The page content analyzer 708 in this example is responsible for extracting page aboutnesses by analyzing the fetched content of the page by a page aboutness extracting unit 718. The page aboutnesses include one or more keywords or entities, e.g., name entities of people or events, which represent the main topic of the page content. Any known method such as natural language processing may be applied to extract page aboutness from the page content. For example, for a webpage reporting President Obama's Health Reform Act news, the page aboutnesses may include “health reform act” and “obama.” The page aboutnesses may be also extracted by page rank based link analysis algorithms, which analyze the anchor texts of the content or by analyzing query and click logs, which provide queries associated with pages in search results. Each extracted page aboutness may be associated with a relevance score indicating the degree of relevancy for a particular page, which is used by a page aboutness ranking unit 720 of the page content analyzer 708 to rank all the extracted page aboutnesses for the particular page. The ranked page aboutnesses for the requested page are then sent to the page identifier-aboutness indexer 710 of the page aboutness database 310. The page identifier-aboutness indexer 710 in this example is configured to index the ranked page aboutnesses with the page identifier and store the indexed page aboutnesses and the page identifier in the aboutness archive 714 and page identifier archive 712, respectively.

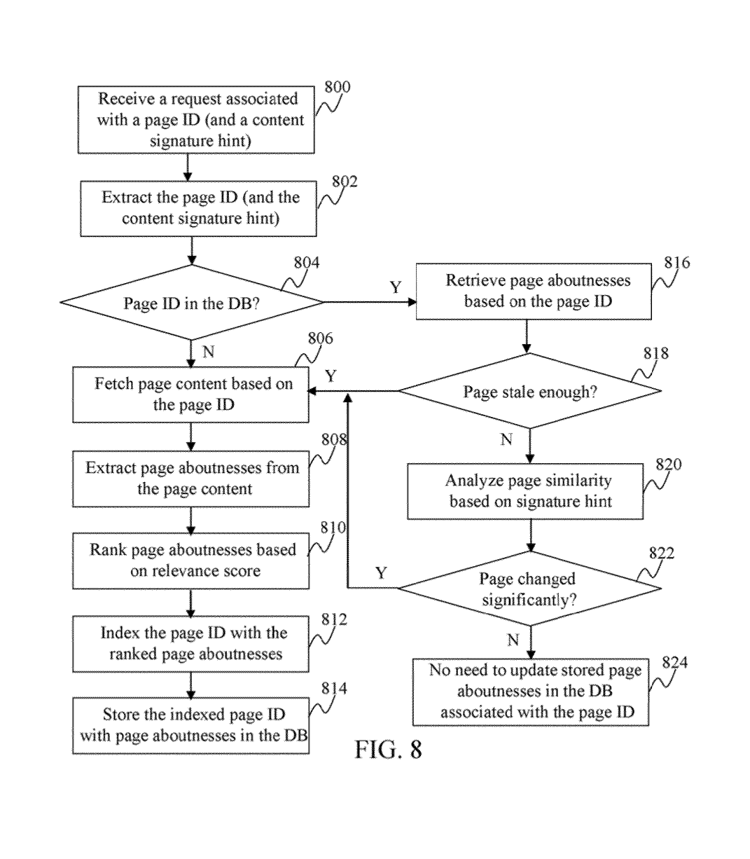

FIG. 8 is a flowchart of an exemplary process in which context-based query suggestion is performed, according to an embodiment of the present teaching. It will be described with reference to the above figures. However, any suitable module or unit may be employed. Beginning at block 800, a request associated with a page identifier for analyzing a plurality of page aboutnesses of a page on which a user is browsing is received. Optionally, the request may be also associated with a page content signature hint. At block 802, the page identifier and the page content signature hint if any are extracted. As described above, blocks 800, 802 may be performed by the page identifier extractor 702 of the page aboutness analyzing engine 304. At block 804, processing may continue where whether the page identifier is stored in a database is determined. As described above, this may be performed by the page identifier evaluator 704 of the page aboutness analyzing engine 304. If the requested page does not have its aboutness stored already, at block 806, content of the requested page is fetched based on the page identifier. As described above, this may be performed by the page content fetcher 706 of the page aboutness analyzing engine 304. Moving to block 808, page aboutnesses are extracted by analyzing the fetched content of the page. At block 810, page aboutnesses are ranked based on a relevance score associated with each page aboutness for the requested page. As described above, blocks 808, 810 may be performed by the page content analyzer 708 of the page aboutness analyzing engine 304. Proceeding to block 812, the ranked page aboutnesses are indexed with the page identifier. At block 814, the indexed page aboutnesses and the page identifier are stored in a database. As described above, blocks 812, 814 may be performed by the page aboutness database 310.

Backing to block 804, if the answer at block 804 is yes, at block 816, the corresponding page aboutnesses already stored in the database are retrieved based on the index with the page identifier. At block 818, processing may continue where whether the stored page aboutnesses need to be updated is determined based on page staleness criteria. If the stored page aboutnesses are stale enough, the processing continues to block 806 to re-analyze the page content and extract the updated page aboutness. If the stored page aboutnesses are not stale enough and a page content signature hint has been extracted from the request, then at block 818, a page content signature is retrieved based on the stored page identifier from the database and compared with the extracted page content signature hint to determine their difference. At block 820, whether the page content has been significantly changed since last update is determined based on the difference between the page content signature hint and page content signature. If the page content has been changed significantly since last update, the processing continues to block 806 to re-analyze the page content and extract the updated page aboutness. Otherwise, there is no need to update the stored page aboutnesses in the database for the page on which the user is browsing. Although the processing in FIG. 8 is illustrated in a particular order, those having ordinary skill in the art will appreciate that the processing can be performed in different orders.

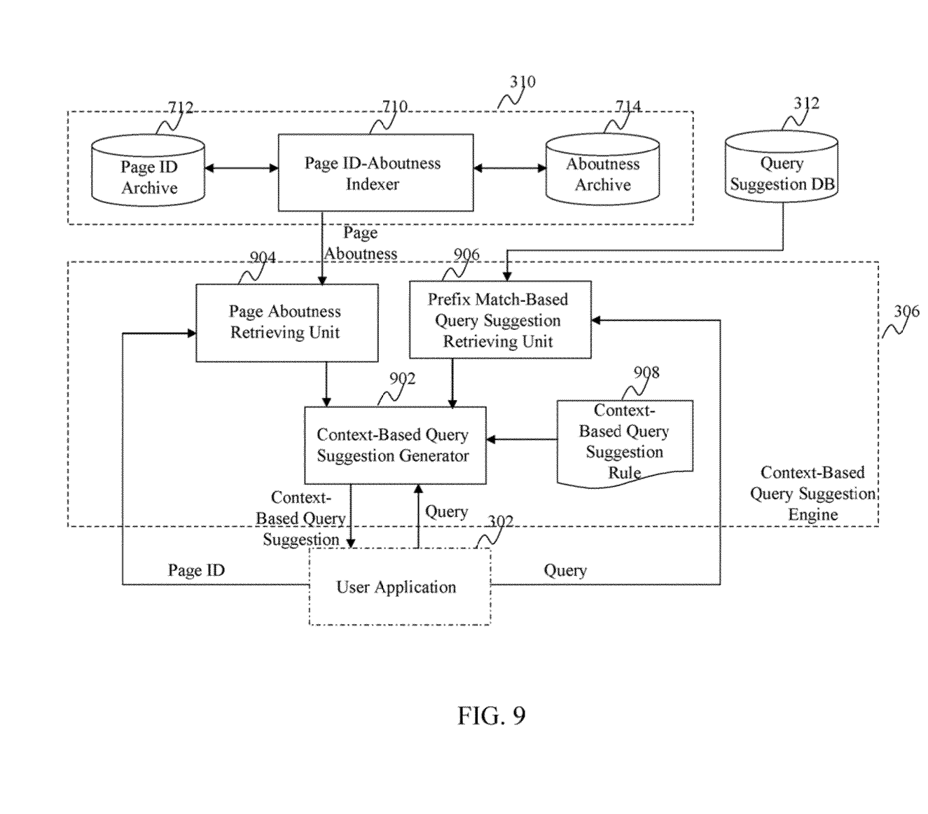

FIG. 9 is an exemplary diagram of a context-based query suggestion engine of the system for context-based query suggestion shown in FIG. 3, according to an embodiment of the present teaching. The context-based query suggestion engine 306 in this example includes a context-based query suggestion generator 902, a page aboutness retrieving unit 904, and a prefix matching-based query suggestion retrieving unit 906. The page aboutness retrieving unit 904 is configured to receive a user input associated with a request for query suggestion and a page identifier for identifying a page on which a user is browsing. It is understood that the user input is not limited to entering a search query but may also include any other predefined action such as moving a cursor to the search box or pressing certain keys. The page aboutness retrieving unit 904 is further configured to fetch page aboutness of the page from the page aboutness database 310 based on the received page identifier. In this example, the page identifier-aboutness indexer 710 may be responsible for identifying the corresponding ranked page aboutnesses for the received page identifier based on their index.

In this example, the prefix matching-based query suggestion retrieving unit 906 may be applied to retrieve query suggestions from the query suggestion database 312 in a way that is similar in the prior art system 100. The retrieved query suggestions may be utilized by the context-based query suggestion generator 902 if the page aboutness analyzing engine 304 has not yet generated the page aboutness when the user sends the request for query suggestion. In this extreme case, the system 300 may gracefully fall back to the mode in the prior art system 100. In addition, both the retrieved query suggestions and the page aboutnesses may be utilized by the context-based query suggestion generator 902 to generate hybrid query suggestions.

The context-based query suggestion generator 902 in this example is configured to determine a plurality of query suggestions based on the fetched page aboutnesses and provide the context-based query suggestions to the user application 302. In this example, the determination may be made in accordance with a context-based query suggestion rule 908. For example, if the user input is not associated with any query, i.e., suggestions before the user types, the query suggestions come from the ranked page aboutnesses fetched from the page aboutness database 310. If the available page aboutnesses for the page are not enough to fill the query suggestion list, the query suggestions retrieved by the prefix matching-based query suggestion retrieving unit 906 may backfill the empty slots. If the user input is associated with a query, i.e., the user already starts to type a query string in the search box, the rule may include: (1) the top n suggestions come from the n page aboutnesses on top of the ranking regardless of whether there is a prefix matching with the received query string (the top n suggestions may be presented in a different visual style to indicate that they are not coming from prefix matching); (2) the rest of suggestions come from the rest page aboutnesses if there is any prefix matching with the received query string; and (3) if there are not enough suggestions from the previous steps, the empty slots in the list are backfilled with query suggestions retrieved from query suggestion database 312 with prefix matching with the received query string. It is understood that, in other examples, different rules may be applied by the context-based query suggestion generator 902 as long as the page aboutness of a particular page on which the user is browsing is applied to provide context-based query suggestions, which are more relevant to the user's interest and search intent by analyzing the user's current browsing behavior.

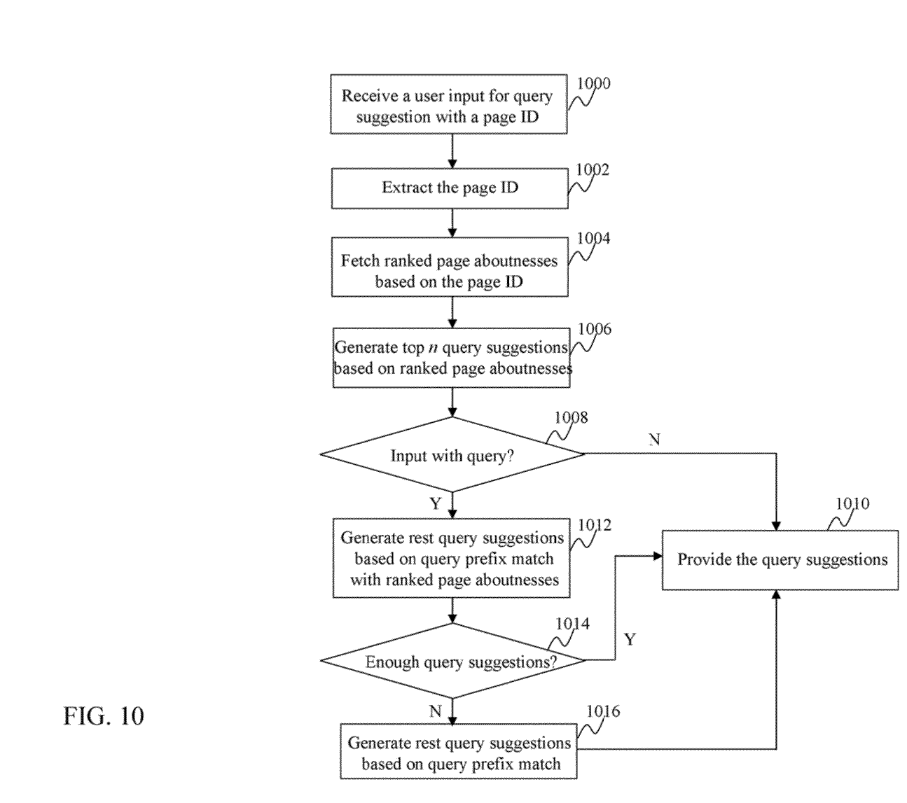

FIG. 10 is a flowchart of an exemplary process in which context-based query suggestion is performed, according to an embodiment of the present teaching. It will be described with reference to the above figures. However, any suitable module or unit may be employed. Beginning at block 1000, a user input is received. The user input is associated with a request for query suggestion and a page identifier for identifying a page on which a user is browsing. At block 1002, the page identifier is extracted. At block 1004, processing may continue where a plurality of page aboutnesses of the page are fetched from a database based on the received page identifier. As described above, block 1000, 1002, 1004 may be performed by page aboutness retrieving unit 904 of the context-based query suggestion engine 306. At block 1006, the top n query suggestions in a query suggestion list are generated based on the top n page aboutnesses on top of the ranking. In one example, n equals to 2. For example, when the user is browsing on a webpage reporting President Obama's Health Reform Act news, the top two query suggestions based on page aboutness may be “health reform act” and “obama.” Moving to block 1008, whether the user input is associated with a query is determined. If no query has been entered yet, the top n page aboutnesses are provided as the query suggestions to the user at block 1010. If the answer at block 1008 is yes, at block 1012, processing may continue where the rest query suggestions are generated based on query prefix matching with the page aboutnesses. All the page aboutnesses that are prefix matched with the received query may be also included in the query suggestion list and provided to the user at block 1010 if it is determined that there are enough query suggestions to fulfill the list at block 1014. Otherwise, the empty slots in the list are backfilled with query suggestions generated by prefix matching with the received query at block 1016 and provided to the user at block 1010. As described above, block 1008, 1010, 1012, 1014, 1016 may be performed by context-based query suggestion generator 902 of the context-based query suggestion engine 306.

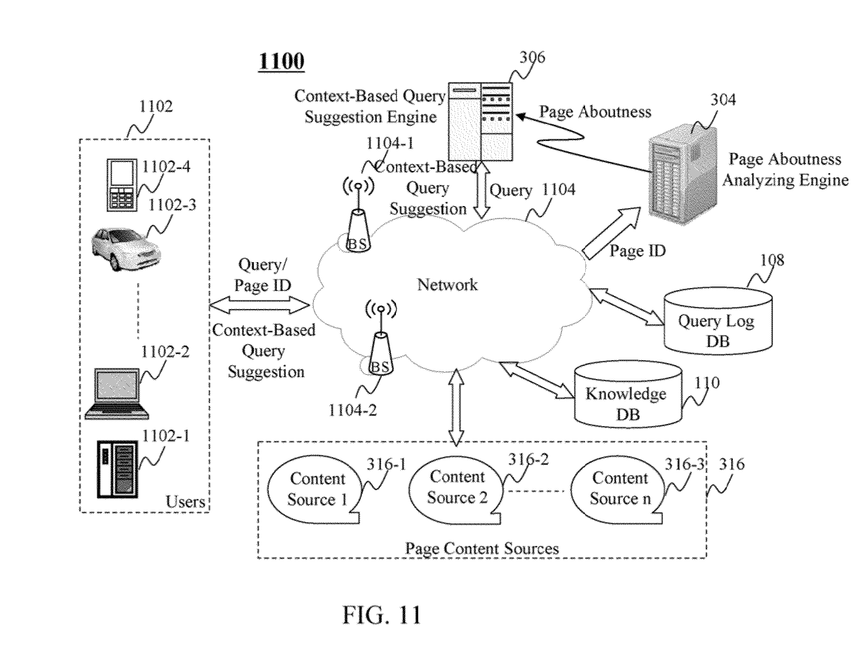

FIG. 11 depicts an exemplary embodiment of a networked environment in which context-based query suggestion is applied, according to an embodiment of the present teaching. In FIG. 11, the exemplary networked environment 1100 includes the context-based query suggestion engine 306, the page aboutness analyzing engine 304, one or more users 1102, a network 1104, page content sources 316, the query log database 108, and the knowledge database 110. The network 1104 may be a single network or a combination of different networks. For example, the network 1104 may be a local area network (LAN), a wide area network (WAN), a public network, a private network, a proprietary network, a Public Telephone Switched Network (PSTN), the Internet, a wireless network, a virtual network, or any combination thereof. The network 1104 may also include various network access points, e.g., wired or wireless access points such as base stations or Internet exchange points 1104-1, . . . , 1104-2, through which a data source may connect to the network in order to transmit information via the network.

Users 1102 may be of different types such as users connected to the network 1104 via desktop computers 1102-1, laptop computers 1102-2, a built-in device in a motor vehicle 1102-3, or a mobile device 1102-4. A user 1102 may send a query to the context-based query suggestion engine 306 via the network 1104 and receive context-based query suggestions from the context-based query suggestion engine 306. A page identifier of the page on which the user 1102 is browsing is sent to the context-based query suggestion engine 306 and page aboutnesses analyzing engine via the network 1104. The page aboutness of the requested page is provided to the context-based query suggestion engine 306 by the page aboutness analyzing engine 304 in order to generate context-sensitive query suggestion. In addition, the context-based query suggestion engine 306 may also access additional information, via the network 1104, stored in the query log database 108 and knowledge database 110 for fetching other query suggestions based on users' search behavior. The information in the query log database 108 and knowledge database 110 may be generated by one or more different applications (not shown), which may be running on the context-based query suggestion engine 306, at the backend of the context-based query suggestion engine 306, or as a completely standalone system capable of connecting to the network 1104, accessing information from different sources, analyzing the information, generating structured information, and storing such generated information in the query log database 108 and knowledge database 110.

The page content sources 316 include multiple content sources 316-1, 316-2, . . . , 316-3, such as vertical content sources. A content source may correspond to a website hosted by an entity, whether an individual, a business, or an organization such as USPTO.gov, a content provider such as cnn.com and Yahoo.com, a social network website such as Facebook.com, or a content feed source such as tweeter or blogs. The page aboutness analyzing engine 304 and user application may access information from any of the content sources 316-1, 316-2, . . . , 316-3. For example, the page aboutness analyzing engine 304 may fetch content, e.g., webpages, through its page content fetcher.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

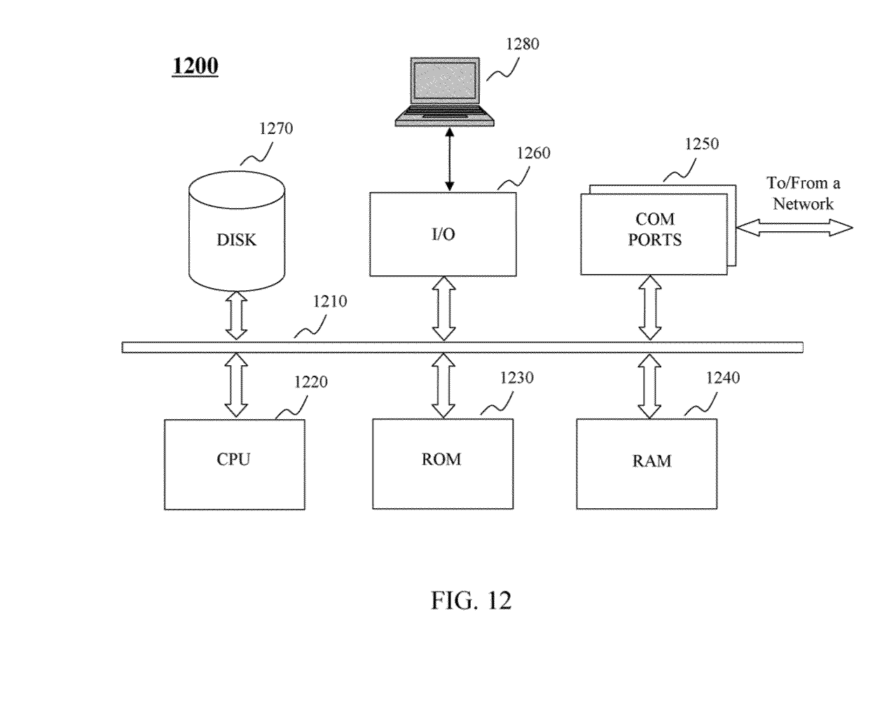

FIG. 12 depicts a general computer architecture on which the present teaching can be implemented and has a functional block diagram illustration of a computer hardware platform that includes user interface elements. The computer may be a general-purpose computer or a special purpose computer. This computer 1200 can be used to implement any components of the query suggestion architecture as described herein. Different components of the system, e.g., as depicted in FIG. 3, can all be implemented on one or more computers such as computer 1200, via its hardware, software program, firmware, or a combination thereof. Although only one such computer is shown, for convenience, the computer functions relating to query suggestion may be implemented in a distributed fashion on a number of similar platforms, to distribute the processing load.

The computer 1200, for example, includes COM ports 1202 connected to and from a network connected thereto to facilitate data communications. The computer 1200 also includes a central processing unit (CPU) 1204, in the form of one or more processors, for executing program instructions. The exemplary computer platform includes an internal communication bus 1206, program storage and data storage of different forms, e.g., disk 1208, read only memory (ROM) 1210, or random access memory (RAM) 1212, for various data files to be processed and/or communicated by the computer, as well as possibly program instructions to be executed by the CPU 1204. The computer 1200 also includes an I/O component 1214, supporting input/output flows between the computer and other components therein such as user interface elements 1216. The computer 1200 may also receive programming and data via network communications.

Hence, aspects of the method of query suggestion, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the units of the host and the client nodes as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method, implemented on at least one machine each of which has at least one processor, storage, and a communication platform connected to a network for context-based query suggestion, the method comprising the steps of:
receiving a user input associated with a request for query suggestion and a page identifier for identifying a page on which a user is browsing;
fetching a plurality of page aboutnesses of the page from a database based on the received page identifier;
determining a plurality of query suggestions based on the fetched plurality of page aboutnesses; and
providing the determined plurality of query suggestions to the user.

2. The method of claim 1, further comprising the steps of:
receiving a request associated with the page identifier for analyzing the plurality of page aboutnesses of the page on which the user is browsing;
determining whether the requested page aboutnesses can be fetched from the database based on the page identifier;
If the requested page aboutnesses cannot be fetched from the database, fetching content of the page based on the page identifier; and
extracting the plurality of page aboutnesses by analyzing the fetched content of the page.

3. The method of claim 2, wherein the step of determining whether the requested page aboutnesses can be fetched from the database comprises:
determining whether the page identifier is stored in the database;
if the page identifier is stored in the database, retrieving stored page aboutnesses associated with the stored page identifier from the database; and
determining whether the stored page aboutnesses need to be updated based on page staleness criteria.

4. The method of claim 2, wherein the step of determining whether the requested page aboutnesses can be fetched from the database comprises:
receiving a page content signature hint associated with the request for analyzing the plurality of page aboutnesses;
determining whether the page identifier is stored in the database;
if the page identifier is stored in the database, retrieving a page content signature based on the stored page identifier from the database; and
determining whether stored page aboutnesses associated with the stored page identifier need to be updated based on a difference between the received page content signature hint and the retrieved page content signature.

5. The method of claim 1, wherein the step of determining a plurality of query suggestions comprises:
ranking the plurality of page aboutnesses based on a relevance score associated with each page aboutness; and
generating a first plurality of query suggestions based on a plurality of page aboutnesses on top of the ranking.

6. The method of claim 5, wherein the step of determining a plurality of query suggestions further comprises:
receiving a query associated with the user input; and
generating a second plurality of query suggestions based on prefix matching of the query with the ranked plurality of page aboutnesses.

7. The method of claim 2, wherein the plurality of page aboutnesses are further extracted by page ranking using link analysis approaches and by analyzing query and click logs.

8. A system for context-based query suggestion comprising a context-based query suggestion engine and a page aboutness analyzing engine, the context-based query suggestion engine comprising:
a page aboutness retrieving unit configured to:
receive a user input associated with a request for query suggestion and a page identifier for identifying a page on which a user is browsing, and
fetch a plurality of page aboutnesses of the page from a database based on the received page identifier; and
a context-based query suggestion generator configured to:
determine a plurality of query suggestions based on the fetched plurality of page aboutnesses, and
provide the determined plurality of query suggestions to the user.

9. The system of claim 8, wherein the page aboutness analyzing engine comprises:
a page identifier extractor configured to receive a request associated with the page identifier for analyzing the plurality of page aboutnesses of the page on which the user is browsing;
a page identifier evaluator configured to determine whether the requested page aboutnesses can be fetched from the database based on the page identifier;
a page content fetcher configured to, if the requested page aboutnesses cannot be fetched from the database, fetch content of the page based on the page identifier; and
a page content analyzer configured to extract the plurality of page aboutnesses by analyzing the fetched content of the page.

10. The system of claim 9, wherein the page identifier evaluator is further configured to:
determine whether the page identifier is stored in the database;
if the page identifier is stored in the database, retrieve stored page aboutnesses associated with the stored page identifier from the database; and
determine whether the stored page aboutnesses need to be updated based on page staleness criteria.

11. The system of claim 9, wherein the page identifier evaluator is further configured to:
receive a page content signature hint associated with the request for analyzing the plurality of page aboutnesses;
determine whether the page identifier is stored in the database;
if the page identifier is stored in the database, retrieve a page content signature based on the stored page identifier from the database; and
determine whether stored page aboutnesses associated with the stored page identifier need to be updated based on a difference between the received page content signature hint and the retrieved page content signature.

12. The system of claim 8, wherein the context-based query suggestion generator is further configured to:
rank the plurality of page aboutnesses based on a relevance score associated with each page aboutness; and
generate a first plurality of query suggestions based on a plurality of page aboutnesses on top of the ranking.

13. The system of claim 12, wherein the context-based query suggestion generator is further configured to:
receive a query associated with the user input; and
generate a second plurality of query suggestions based on prefix matching of the query with the ranked plurality of page aboutnesses.

14. The system of claim 9, wherein the plurality of page aboutnesses are further extracted by page ranking using link analysis approaches and by analyzing query and click logs.

15. A machine-readable tangible and non-transitory medium having information for context-based query suggestion recorded thereon, wherein the information, when read by the machine, causes the machine to perform the following:
receiving a user input associated with a request for query suggestion and a page identifier for identifying a page on which a user is browsing;
fetching a plurality of page aboutnesses of the page from a database based on the received page identifier;
determining a plurality of query suggestions based on the fetched plurality of page aboutnesses; and
providing the determined plurality of query suggestions to the user.

16. The medium of claim 15, further comprising the steps of:
receiving a request associated with the page identifier for analyzing the plurality of page aboutnesses of the page on which the user is browsing;
determining whether the requested page aboutnesses can be fetched from the database based on the page identifier;
If the requested page aboutnesses cannot be fetched from the database, fetching content of the page based on the page identifier; and
extracting the plurality of page aboutnesses by analyzing the fetched content of the page.

17. The medium of claim 16, wherein the step of determining whether the requested page aboutnesses can be fetched from the database comprises:
determining whether the page identifier is stored in the database;
if the page identifier is stored in the database, retrieving stored page aboutnesses associated with the stored page identifier from the database; and
determining whether the stored page aboutnesses need to be updated based on page staleness criteria.

18. The medium of claim 16, wherein the step of determining whether the requested page aboutnesses can be fetched from the database comprises:
receiving a page content signature hint associated with the request for analyzing the plurality of page aboutnesses;
determining whether the page identifier is stored in the database;
if the page identifier is stored in the database, retrieving a page content signature based on the stored page identifier from the database; and
determining whether stored page aboutnesses associated with the stored page identifier need to be updated based on a difference between the received page content signature hint and the retrieved page content signature.

19. The medium of claim 15, wherein the step of determining a plurality of query suggestions comprises:
ranking the plurality of page aboutnesses based on a relevance score associated with each page aboutness; and
generating a first plurality of query suggestions based on a plurality of page aboutnesses on top of the ranking.

20. The medium of claim 19, wherein the step of determining a plurality of query suggestions further comprises:
receiving a query associated with the user input; and
generating a second plurality of query suggestions based on prefix matching of the query with the ranked plurality of page aboutnesses.

21. The medium of claim 16, wherein the plurality of page aboutnesses are further extracted by page ranking using link analysis approaches and by analyzing query and click logs.

22. A method, implemented on at least one machine each of which has at least one processor, storage, and a communication platform connected to a network for context-based query suggestion, the method comprising the steps of:
receiving a request associated with a page identifier for analyzing a plurality of page aboutnesses of a page on which a user is browsing, the page being identified by the page identifier;
fetching content of the page based on the page identifier;
extracting the plurality of page aboutnesses by analyzing the fetched content of the page;
ranking the plurality of page aboutnesses based on a relevance score associated with each page aboutness;
indexing the ranked plurality of page aboutnesses with the page identifier; and
storing the indexed plurality of page aboutnesses and the page identifier in a database, wherein
at least some of the stored plurality of page aboutnesses are used as query suggestions in response to a user input associated with a request for query suggestion and the page identifier.

23. A method, implemented on at least one machine each of which has at least one processor, storage, and a communication platform connected to a network for context-based query suggestion, the method comprising the steps of:
sending a request associated with a page identifier for analyzing a plurality of page aboutnesses of a page on which a user is browsing, the page being identified by the page identifier;
sending a user input associated with a request for query suggestion and the page identifier; and
receiving a plurality of query suggestions as a response to the user input, wherein content of the page is fetched based on the page identifier,
a plurality of page aboutnesses are extracted based on the content of the page, and
the plurality of query suggestions are determined based on the plurality of page aboutnesses.

24. The method of claim 23, further comprising:
creating a page content signature hint based on the content of the page, the page content signature hint being associated with the request for analyzing the plurality of page aboutnesses, wherein the request for analyzing the plurality of page aboutnesses is automatically sent after the page is fully loaded by an application.

25. The method of claim 23, wherein the request for analyzing the plurality of page aboutnesses is automatically sent once an application starts to load the page.
